(19) United States
(12) Patent Application Publication
(10) Pub. No.: US 2009/0248530 A1
(43) Pub. Date: Oct. 1, 2009

(54) POS REGISTER, COOKING INSTRUCTION METHOD, COOKING INSTRUCTION PROGRAM AND PROGRAM RECORDING MEDIUM

(76) Inventor: MASAKAZU ITO, Kanagawa (JP)

Correspondence Address: NEC CORPORATION OF AMERICA, 6535 N. STATE HWY 161, IRVING, TX, 75039, US

(21) Appl. No.: 12/408,159

(22) Filed: Mar. 20, 2009

(30) Foreign Application Priority Data
Mar. 25, 2008 (JP) 076944/2008

(51) Int. Cl. G06Q 50/00; G06Q 30/00; G06Q 10/00; G06F 3/048

(52) U.S. Cl. 705/15; 705/21; 705/26; 715/810

(57) ABSTRACT

A POS register 1 is provided with a product master setting table 121 and a fire button 161. All menus are registered as products in the product master setting table 121 together with a hold number for each menu of a course menu. When the fire button 161 is pushed down upon receiving an order of a course menu, cooking instructions for the menu having the earliest hold number among the menus of the course menu are outputted to the kitchen printer 2 in the kitchen 200 except the menus whose cooking instructions are already outputted. When the fire button 161 is pushed down under the condition of selecting either one menu or inputting a numerical value corresponding to the hold number, cooking instructions for the applicable menu are outputted.

### INCORPORATION BY REFERENCE

This application is based upon and claims the benefit of priority from Japanese patent application No. 2008-076944, filed on Mar. 25, 2008, the disclosure of which is incorporated herein in its entirety by reference.

### TECHNICAL FIELD

This invention relates to a POS (Point of Sales) register, a cooking instruction method, a cooking instruction program and a program recording medium.

### BACKGROUND ART

As disclosed in Japanese patent publication no. 2000-268082 entitled “Order Data Management Apparatus”, it is conventional in restaurants that cooking instructions of ordered menus (products) to the kitchen are normally made by inputting the name of menus (products) into a POS register and pushing down a button (transmission button or the like) to send it for printing on a sheet of paper by a kitchen printer. Some POS registers have a function to print the menus on a kitchen printer in response to a predetermined cooking time.

In case of a restaurant that provides, for example, a course menu such as four kinds of dishes, for example, soup, salad, main dish and desert, the timing to start cooking each dish (menu) is preset in advance so that next dish will be served sequentially to the customer with an appropriate time difference when he/she finish one dish. As a result, it ensures that the respective menus of the ordered course menu are not served in an awkward sequence. That is, for example, the main dish is not served first and attention is paid in the timing of serving the respective dishes so that the next dish is served before the customer finishes one dish.

However, when several customers come to a restaurant in a group to enjoy a course menu, there are certain differences in the speed of finishing each menu of the course menu. This means that some of the customers may not finish a menu in a preset time. Moreover, there are circumstances where some customers order different course menus from rest of the customers. It is therefore understood that, even if finishing times of various menus of different course menus may be preset, it is necessary or preferable that the timing of serving menus such as a salad, a main dish or the like should be substantially equal to each customer in the same group.

It is therefore necessary that floor staffs of the restaurant send instructions to the kitchen printer so that each menu of respective course menu will be served simultaneously to the customers in a group. Unfortunately, no conventional POS registers have a function for sending cooking instructions for simultaneously serving respective menus of a course menu to the customers in a group. This means that the floor staffs are required to make own judgment to orally instruct cooks or cocking staffs in the kitchen. However, since there are no records of such oral cooking instructions on a sheet of paper or the like in the kitchen, the cooks may sometime forget to timely cook some menus.

Moreover, in case of a POS register in which the cooking time can be preset, cooking instructions to start cooking a certain menu are automatically outputted to a kitchen printer at the lapse of the preset time from the order time. However, as mentioned hereinabove, the finishing time of each menu differs from one customer to another, thereby causing time differences (or errors) between the times of completing the cooking and serving the menu to the customer.

### SUMMARY

In light of the above circumstances, it is an object of the invention to provide a POS register, a cooking instruction method, a cooking instruction program and a program recording medium capable of outputting cooking instructions at the timing proper to serve respective menus regardless of the number of customers in a group.

In order to achieve the above object, the POS register, the cooking instruction method, the cooking instruction program and the program recording medium of the invention employ the following unique constructions.

(1) A first exemplary embodiment of a first aspect according to the invention is a POS register for providing to customers products (foods and drinks) cooked in a kitchen at a restaurant, comprising: a product master setting table to set and register information on all menus as products for giving to each dish of a course meal a hold number that represents a sequential order number of cooking instructions; and a fire button for sending cooking instructions to the kitchen; when the fire button is pushed down while receiving an order of a course meal, cooking instructions are sent to the kitchen for the dish of the youngest number in the hold number among the dishes of the course meal but the cooking instructions are not outputted yet.

The POS register, the cooking instruction method, the cooking instruction program and the program recording medium according to the invention exhibit the following exemplary advantages.

A first exemplary advantage of the exemplary POS register according to the invention is the capability of outputting to the kitchen cooking instructions at proper timing for serving to the customer either non-course menu or any menus of, a course menu and regardless of the number of customers in a group because of the provision of the “Fire” button and the “Hold Number” given to each menu to indicate the sequential order of cooking each menu. Also, it is possible to avoid failure of start cooking any meal because the cooking instructions to the kitchen are outputted in printing on a cooking instruction sheet from the kitchen printer

A second exemplary advantage according to the invention is the capability of simultaneously outputting to the kitchen cooking instructions for all menus having the same number as the youngest number in the “Hold Number” among the ordered menus whose cooking instructions are not outputted yet because of giving the “Hold Number” to indicate the cooking order of each menu of a course menu. For instance, in case of serving a course menu to customers in a group, each menu to be served to the customers in the same sequential order can be served simultaneously even if the customers may order different course menus.

A third exemplary advantage according to the invention is the capability of immediately sending cooking instructions of a menu when an order is received from a customer even if the order is non-course menu because cooking instructions of the selected menu are outputted to the kitchen by selecting either one of the ordered menus and pushing down the “Fire” button. Also, in case of a course menu and if the customer wants to change the order of eating menus (dishes), for example, to eat a menu having an older “Hold Number” earlier than the other menus, it is possible to select a particular menu and send its cooking instructions for prioritizing the particular menu.

A fourth exemplary advantage according to the invention is that by pushing down the “Fire” button 161 after inputting any numerical value representing the “Hold Number”, it is possible to output to the kitchen printer 2 cooking instructions for the menus having the same “Hold Number” as the inputted numerical value among the ordered menus (products) excluding the menus (products) whose cooking instructions have been outputted to the kitchen printer 2. Accordingly, when customers in a group who ordered the same or different course menus but want to change the order of the menus to be served, for example to prioritize a menu having an older “Hold Number”, it is possible to output cooking instructions by simply inputting a certain “Hold Number” without the need for selecting names of plural menus, thereby enabling to select menus having the same “Hold Number”.

### BRIEF DESCRIPTION OF THE DRAWINGS

The foregoing and other object and exemplary advantages of the invention will become apparent by reading the following descriptions made with reference to the accompanying drawings, wherein:

FIG. 1 is a block diagram to show configuration of an exemplary embodiment of the POS register according to the invention and an exemplary connection diagram of the POS register and the kitchen printer;

FIG. 2 is an exemplary product master setting table to be used in the POS register as shown in FIG. 1;

FIG. 3 is an illustration of an exemplary screen display on the POS register when customer orders are entered;

FIG. 4 is an illustration of exemplary cooking instructions to be outputted from the kitchen printer; and

FIG. 5 is an exemplary flowchart illustrating the flow of processing in the POS register according to the invention as shown in FIG. 1.

### EXEMPLARY EMBODIMENTS

Now, exemplary embodiments of the POS register, the cooking instruction method, the cooking instruction program and the program recording medium according to the invention will be described with reference to the accompanying drawings. It is to be noted herein that the POS register and the cooking instruction method according to the invention are described in greater detail hereunder but the cooking instruction method can be implemented in form of a cooking instruction program to be executed by a computer. Alternatively, it is needless to say that the cooking instruction program can be recorded in a computer readable recording medium.

### (Features of the Invention)

Prior to detailed description on the exemplary embodiments according to the invention, features of the invention will be first described. The invention is particularly applied to the case of ordering a course meal at a restaurant or the like. The “Hold Number” to indicate the order of cooking instructions is given to each menu of a course menu and the “Hold Numbers” of all menus (products) available at the restaurant are registered in the product master setting table. When an order is received from a customer, the “Hold Number” as registered in the product master setting table is set together with the name of the menu in an ordered menu setting table for setting the ordered menus. It is to be noted that existing or non-existence of the “Hold Number” distinguishes whether ordered menu is a course menu (product) or a non-course or single menu (product).

It is to be noted that cooking instructions on each menu (product) set in the ordered menu setting table and having the “Hold Number” are not outputted to the kitchen printer in the kitchen immediately after completion of order registration on the POS register. When a cooking instruction button that is called a “Fire” button herein provided on the POS register is pushed down, the youngest number of the “Hold Number” among the menus set in the ordered menu setting table but their cooking instructions are not outputted yet to the kitchen printer (i.e., the menu having the earliest order of cooking instructions) is extracted, thereby selecting all of the menus having the same “Hold Number” but excluding those menus whose cooking instructions have been outputted to the kitchen printer for outputting the cooking instructions for such menus to the kitchen printer. Accordingly, for example, in case of serving course menu to customers in a group, it is possible to simultaneously serve each menu to respective customers even if different course menus are ordered.

Also, it is possible to output cooking instructions for only a selected menu (product). In this case, the particular menu (Product) to be outputted to the kitchen printer is selected on the display screen of the POS register, for example, by touching with a finger the particular name of the menu in a list of menus of course menus displayed on the display screen of the POS register. Subsequently, when the “Fire” button is pushed down, cooking instructions for the selected menu (product) are outputted to the kitchen printer. Accordingly, it is possible to send cooking instructions for the ordered menu as soon as the order is received. It is also possible to change the order of serving menus of a course menu. For example, if the customer desires to change the order of menus of the course menu to be served, thereby enabling to select a particular menu having an older “Hold Number” for sending cooking instructions prior to other menus. It is to be noted that when plural menus (products) are selected, cooking instructions for the selected plural menus (products) are outputted to the kitchen printer.

Furthermore, by entering the number representing the “Hold Number” into the POS register prior to push down the “Fire” button of the POS register, outputted to the kitchen printer are cooking instructions for the menus (products) having the same number as the entered “Hold Number” excluding menus (products) whose cooking instructions have been outputted to the kitchen printer.

Accordingly, for example, if any customer in a group who ordered course menus desires to change the order of menus to be served, i.e., to eat a menu having an cider “Hold Number” prior to other menus, it is possible to simply enter a particular “Hold Number”, thereby enabling to select menus having the same “Hold Number” and sending their cooking instructions without the need for selecting the names of plural menus.

It is to be noted that in case of menus (products) having no “Hold Number”, it is possible to output their cooking instructions to the kitchen printer at the time when the order registrations are completed on the POS register without pushing down the “Fire” button if it is desirable.

### Exemplary Embodiments of the Invention

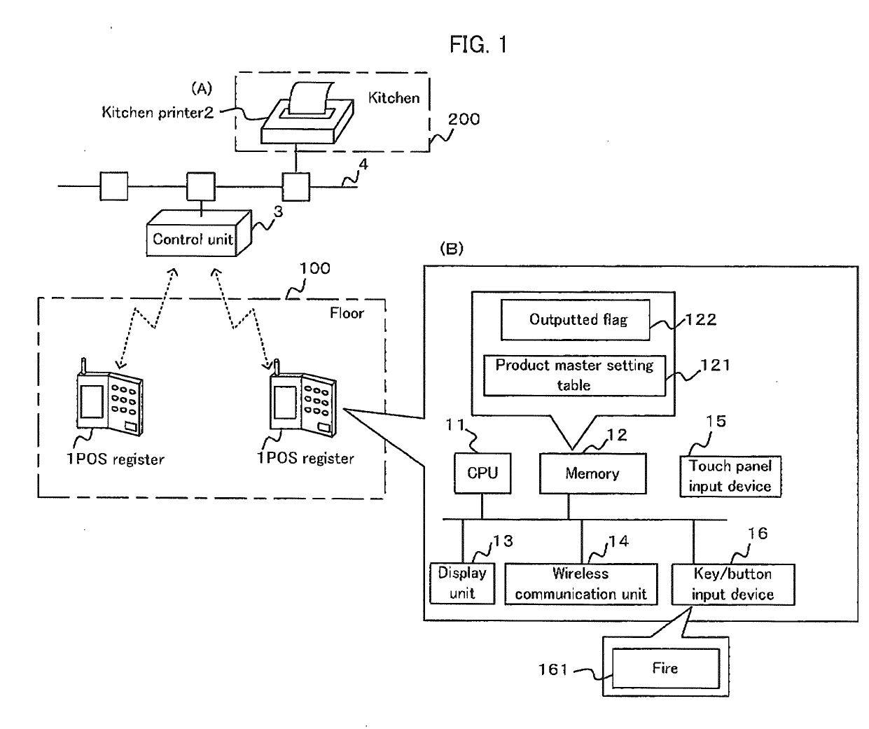

Now, an exemplary embodiment of the POS register according to the invention will be described with reference to FIG. 1. FIG. 1 illustrates an exemplary block diagram of the POS register according to the invention and a connection diagram between the POS register and the kitchen printer. FIG. 1 (A) illustrates the connection diagram between the POS register 1 and the kitchen printer 2, while FIG. 1 (B) illustrates the block diagram of the POS register 1.

As shown in FIG. 1 (A), a plurality of POS registers 1 are carried by floor staffs who serve for customers within a floor 100 where menus are served to customers. The POS registers 1 are connected to a control unit 3 for communication by radio wave signals or infrared signals. The control unit 3 is also connected by way of a LAN cable 4 to a kitchen printer 2 that is located in a kitchen 200 for cooking various menus. In other words, cooking instruction information from the POS registers 1 to the kitchen printer 2 is transmitted to the control unit by radio signals or infrared signals. Consequently, the signals are transmitted from the control unit 3 to the kitchen printer 2 by way of the LAN cable 4 for outputting cooking instructions in printing on a sheet of paper.

In the shown exemplary embodiment, the POS registers 1 are a foldable type each having a display section with a touch panel function on the front part of a main body and a key/button input section on the rear part of a foldable section. Customer's table number, check number, ordered menus and the like are inputted by operating the key/button input section and the touch panel. The inputted data can be sent to the kitchen printer for outputting cooking instructions after checking on the display in the display section. Also, the POS registers 1 may be used for calculation of charges and sales processing. It is to be noted that the POS registers 1 may be another type having a display section with touch panel function and a key/button input section on the front of a main body unlike the foldable type as shown in FIG. 1. Alternatively, the POS registers 1 are not limited to the portable type but may be a fixed type or any other type that is operated by customers.

Although the kitchen printer 2 disposed in the kitchen 200 is connected by way of the LAN cable 4 in the exemplary embodiment as shown in FIG. 1, it may be a wireless printer. Moreover, in addition to the kitchen printer 2, it is possible to provide a kitchen display having a display screen for displaying cooking instruction information from the POS registers 1 together with the printed cooking instructions on a cooking instruction sheet.

It is to be noted that each of the POS registers 1 has the same construction and comprises at least a CPU 11, a memory 12, a display unit 13, a wireless communication unit 14, a touch panel input device 15 and a key/button input device 16. The CPU 11 is designed to provide overall control of each POS register 1, i.e., control the operations of all circuit blocks.

The memory 12 are designed to store various control programs such as an order receiving program, a cooking instruction program, an accounting program, a sales calculation program and the like, a product master setting table 121 for registering all available menus, control tables for error display information and the like, an ordered menu setting table for setting information on menus ordered by customers, various data such as display information on the display unit 13 and the like. It is to be noted that the ordered menu setting table contains an output flag 122 to indicate whether cooking instructions for each menu set in the ordered menu setting table has been outputted to the kitchen printer 2. Furthermore, if each menu is a part of a course menu, the “Hold Number” to indicate the sequential order of cooking is also saved by copying from the product master setting table 121.

The display unit 13 comprises a liquid crystal display panel disposed in front of the touch panel for displaying a menu list of all menus as set in the product master setting table 121, an ordered menu list of all menus as set in the ordered menu setting table, a sales menu, various guidance displays and the like when taking orders, sending cooking instructions, accounting operations and the like. The wireless communication unit 14 is designed to send wireless or infrared signals for cooking instructions to the kitchen printer 2 or receive from a shop server or the like (not shown) wireless or infrared signals for renewal instructions of the product master setting table 121.

The touch panel input device 15 is designed to input the positional information of the touch panel in front of the display unit 13 touched by an operator, thereby notifying a particular item (menu) selected from the items displayed on the display screen at the time when touched by the operator. On the other hand, the key/button input device 16 is designed to input numerical information such as the customer's table number, the check number and the “Hold Number” unique to the invention and also input by operating the “Fire” button 161 for cooking instructions, the accounting button asking for a check and the like.

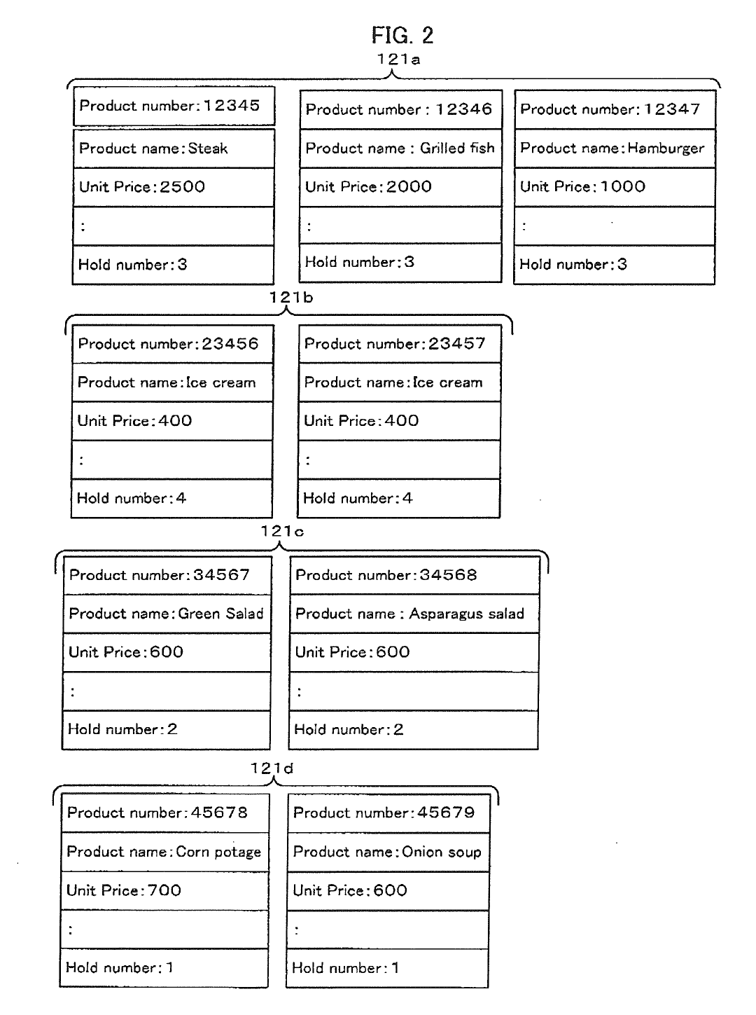

Now, an example of the product master setting table 121 stored in the memory 12 will be described in detail. FIG. 2 is an exemplary table of the product master setting table to be used in the POS register 1 according to the invention. It sets and registers all menus (products) available from the shop (restaurant). Various numbers 121a, 121b, 121c, 121d including the “Hold Numbers” unique to the invention other than normal information such as a product number, a product name, a unit price and the like are given to each menu (product) to indicate varieties of dish such as main dishes, deserts, salads, soups, and the like. The “Hold Number” is given only to menus constituting parts of course menus (products). This means that no “Hold Number” is given to non-course menus (products).

The “Hold Number” indicates the sequential order of cooking instructions in case of a course menu. A food having the younger number in the “Hold Number” means to be cooked earlier than the others. In the particular example as shown in FIG. 2, the “Hold Number” given to a variety of soups 121d to be cooked first is “1”, that for a variety of salads 121c to be cooked next is “2”, that for a variety of main dishes 121a to be cooked at the third time is “3” and that for a variety of deserts 121b to be served finally is “4”. In other words, the same “Hold Number” is given to all menus having the same position in a respective course menu even in different course menus.

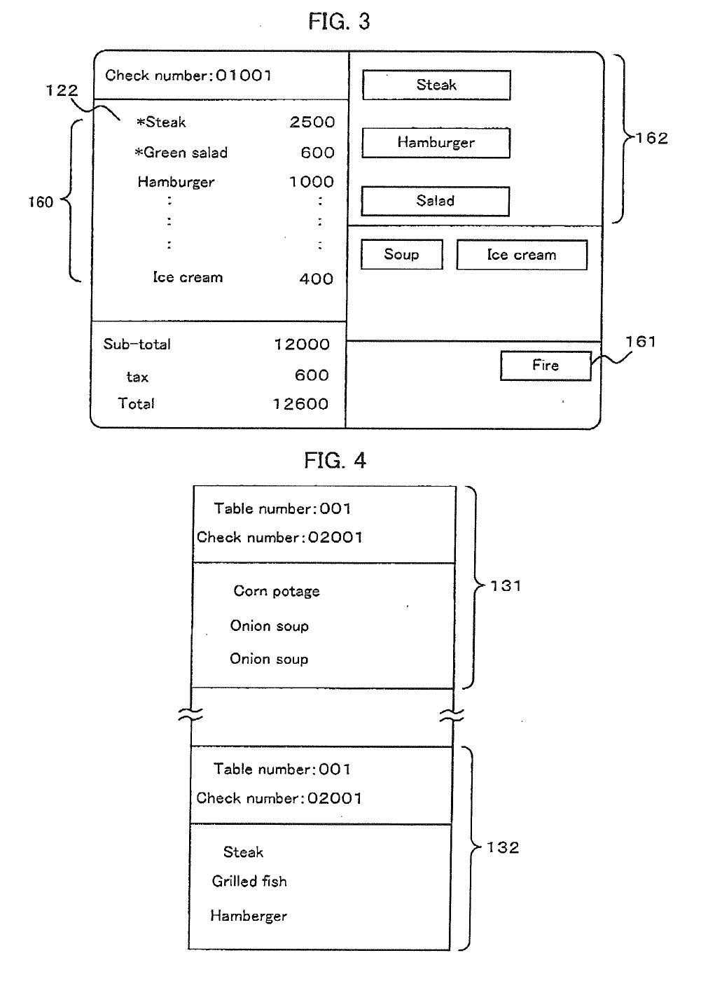

As indicated by a special symbol (*) in FIG. 3, a flag 122 saved in the memory 12 is provided to each menu in the ordered menu setting table that sets and registers menus ordered by a customer as mentioned hereinabove. The flag 122 indicates if the cooking instructions for the particular menu (product) have been outputted to the kitchen printer 2.

An example of the screen display on the POS register 1 when taking an order from a customer is symbolically shown in FIG. 3. In FIG. 3, displayed on the display unit 13 at the left or the main body side of the POS register 1 are particulars 160 of the menus ordered by the customer. On the other hand, disposed at the right or the foldable part of the POS register 1 are the “Fire” button 161 for outputting cooking instructions, the product selection buttons 162 for selecting menus (products) such as steak, hamburger, salad, ice cream, etc.

It is to be noted that the “*” mark at the left end of each column of ordered menu particulars 160 is the flag 122 to indicate that the cooking instructions for the particular menu with the mark on have been outputted to the kitchen printer 2. When either one of the product selection buttons 162 at the right foldable part side is pushed down or touched, the particular menu is selected and the selected menu is displayed on the display unit 13.

In case of setting a representative name of plural menus constituting a group as the product selection button 162, all menus constituting the group will be displayed in a list at the left side of the display unit 13 when the product selection button 162 is pushed down, thereby enabling a floor staff (operator) to touch for selecting either one of the menus in the displayed list. The “Fire” button 161 can be pushed down at any time when taking an order from a customer or when responding any customer's request about serving the foods and drinks, thereby automatically selecting any menu (product) for outputting the cooking instructions of the selected menu (product) from the kitchen printer 2 in the kitchen 200.

FIG. 4 is an exemplary illustration of the cooking instruction sheet that is outputted from the kitchen printer 2 in the kitchen. In this particular example, the cooking instruction sheet includes the table number, the check number and then the menus (products) to be cooked. In the example as shown in FIG. 4, printed are first cooking instructions 131 on soups, i.e., one corn soup and two onion soups to be cooked at first for three customers in a group at the table number “031” and the check number “02001”. Also printed are cooking instructions 132 on main menus, i.e., steak, grilled fish and hamburger to be cooked at n^{-th}.

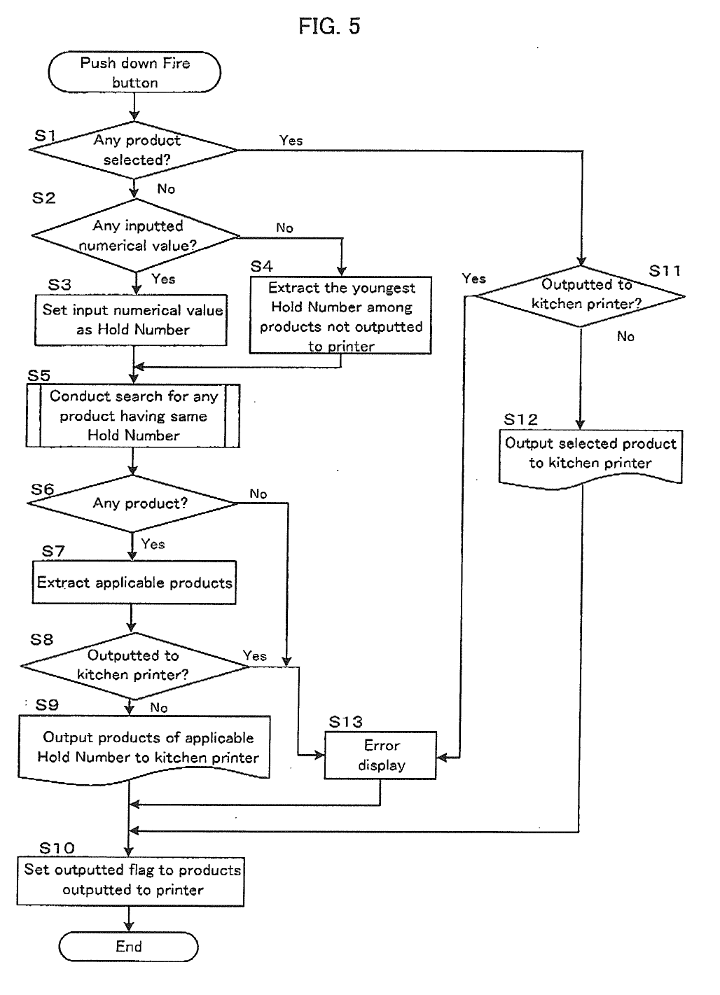

Now, an exemplary processing to output the cooking instructions to the kitchen printer 2 from the POS register 1 according to the invention will be described with reference to the flowchart in FIG. 5. FIG. 5 illustrates an exemplary flowchart to show the flow of cooking instructions in the POS register 1 according to the invention. The flow initiates by pushing down the “Fire” button 161 as shown in FIG. 3.

A series of processing as illustrated in the flowchart in FIG. 5 will be performed within the POS register 1 by pushing down the “Fire” button 161 after selecting either one of the menus, for example, while the particulars of ordered menus 160 as shown in FIG. 3 are displayed on the display screen, by pushing down the “Fire” button 161 after inputting either one of the numbers 121a-121d as shown in FIG. 2 or by simply pushing down the “Fire” button 161.

In the flowchart as shown in FIG. 5, when the “Fire” button 161 for cooking instructions is pushed down, a check is first made if any menu (product) is selected (step S1). If any menu (product) is selected on the display screen of the POS register 1 (“Yes” in step S1), the outputted flag 122 in the ordered menu setting table in the memory 12 is referred to confirm if cooking instructions for the menu (product) that is selected on the screen of the POS register 1 are already outputted to the kitchen printer 2 (step S11).

If cooking instructions are not outputted yet (“No” in step S11), cooking instructions for the selected menu (product) are outputted to the kitchen printer 2 (step S12). Subsequent to outputting the cooking instructions to the kitchen printer 2, the outputted flag 122 for the menu (product) is set in the ordered menu setting table in the memory 12 of the POS register 1 to indicate that the cooking instructions have been outputted to the kitchen printer 2.

On the other hand, if the cooking instructions for the selected menu (product) are already outputted to the kitchen printer 2 (“Yes” in step S11), an error message is displayed on the screen of the POS register 1 to indicate that the cooking instructions are already outputted (step S13) before jumping to step S10.

If no menu (product) is selected on the screen of the POS register 1 in step S1 (“No” in step S1), a check is then made if any numerical value is inputted to the POS register 1 from the key/button input device 16 (step 32).

If no numerical value is inputted to the POS register 1 (“Yes” in step S2), it is assumed that the inputted numerical value is assumed to be the “Hold Number” of the menu (product) constituting a course menu, thereby setting the inputted numerical value as the “Hold Number” (step S3). Then, a search is conducted to find the menus (products) having the same “Hold Number” in the ordered menu setting table in the memory 12 (step S5). It is to be noted that when taking an order for a course menu, the “Hold Number” given to the menu in the ordered menu setting table is extracted from the product master setting table 121 and set thereto.

Based on the search result, a check is made if there is any menu (product) having the same “Hold Number” in the ordered menu setting table (step S6). If no menu (product) to which the same “Hold Number” is given in the table (“No” in step S6), it is assumed that the numerical value inputted to the POS register 1 is erroneous and an error message is displayed on the screen of the POS register to indicate that no applicable menu (product) exists (step S13) before jumping to step S10.

On the other hand, if there is any menu (product) to which the same “Hold Number” is given in the ordered menu setting table (“Yes” in step S6), extracted are all menus (products) to which the same “Hold Number” is given contained in the ordered menu setting table (step S7). Subsequently, a check is made if the cooking instructions for all of extracted the menus (products) are already outputted to the kitchen printer 2 (step SB). If there is any menu (product) whose cooking instructions are not yet outputted to the kitchen printer 2 (“Yes” in step S8), cooking instructions for all of the non-outputted menus (products) are outputted to the kitchen printer 2 (step S9).

This means that if there is any menu (product) having the same “Hold Number” as the inputted numerical value exists in the ordered menu setting table, outputted to the kitchen printer 2 are cooking instructions for all of the menus (products) whose cooking instructions are not yet outputted to the kitchen printer 2 among all of the menus (products) having the same “Hold Number” as the inputted numerical value. After outputting the cooking instructions to the kitchen printer 2, the outputted flags 122 are set to all of the menus (products) whose cooking instructions are outputted in the ordered menu setting table in the memory 12 to indicate that their cooking instructions have been outputted to the kitchen printer 2 (step S10).

It is to be noted that if cooking instructions for all of the menus (products) extracted from the ordered menu setting table are already outputted (“Yes” in step S8), an error message to indicate that cooking instructions have been outputted is displayed on the screen of the POS register (step S13) before jumping to step S10.

If no numerical value is inputted to the POS register 1 in step S2 (“No” in step S2), a search is conducted to identify younger numbers in the “Hold Number” among the menus (products) set in the ordered menu setting table in the memory 12, thereby extracting the menu (product) having the youngest number in the “Hold Number” whose cooking instructions are not outputted to the kitchen printer 2 yet (step S4) before jumping to step S5 for conducting a search in the ordered menu setting table for any menu (product) having the same “Hold Number” (step S5).

Based on the search result, a check is made if there is any other menu (product) in the ordered menu setting table having the same “Hold Number” (step S6). Even if there is no other menu (product) having the same “Hold Number”, there are at least one menus in this instance and thus there is no chance of “No” in step S6.

Accordingly, this is the case when there are menus (products) having the same “Hold Number” in the ordered menu setting table (“Yes” in step S6), extracted are all menus (products) in the ordered menu setting table in the memory 12 to which the “Hold Number” coincides with the youngest “Hold Number” and whose cooking instructions are not outputted yet to the kitchen printer 2 (step S7). Subsequently, a check is made if cooking instructions are already outputted for all of the extracted menus (products) in the ordered menu setting table (step S8).

It is to be noted that there are at least one menus whose cooking instructions are not outputted yet in step S8 in this particular instance, there is no chance of “Yes” in step S8. That is, there are one or more menus (products) whose cooking instructions are not outputted yet (“No” in step S8), therefore outputting the cooking instructions for all of the non-outputted menus (products) to the kitchen printer 2 (step S9).

This means that if there is any applicable product having the same “Hold Number” as the “hold Number” that is extracted in step S4 in the ordered menu setting table, a search is conducted for any menu (product) set in the ordered menu setting table in the memory 12 having the youngest “Hold Number” and its cooking instructions are not outputted yet to the kitchen printer 2. And cooking instructions for all of the menus (products) having the same “Hold Number” and whose cooking instructions are not outputted yet are outputted to the kitchen printer 2.

After outputting the cooking instructions to the kitchen printer 2, the outputted flags 122 to indicate that the cooking instructions have been outputted to the kitchen printer 2 are set to all of the applicable menus (products) in the ordered menu setting table in the memory 12 (step S12).

### (Exemplary Advantages of Exemplary Embodiments)

As described in detail hereinabove, the exemplary embodiments according to the invention exhibit various exemplary advantages as follows:

A first exemplary advantage according to the invention is the capability of outputting cooking instructions to the kitchen at the timing appropriate to the customer not only for a non-course menu but also for menus of a course menus and the number of customers in a group because of provisions of the “Fire” button to send cooking instructions ant also the “Hold Number” given to each menu to indicate the sequential order of cooking each menu. Also, failures of cooking any menu can be effectively avoided because the cooking instructions to the kitchen are outputted in printing on a cooking instruction sheet from the kitchen printer 2.

A second exemplary advantage according to the invention is the capability of simultaneously outputting to the kitchen cooking instructions for all menus having the same number as the youngest “Hold Number” among the menus whose cooking instructions are not outputted yet because of giving the “Hold Number” to each menu of any course menu to indicate the sequential order to be cooked. For instance, when serving course menus to customers in a group, even if each menu in the course menu may be different, it is possible to simultaneously serve to the customers menus that are supposed to be served simultaneously.

A third exemplary advantage according to the invention is the capability of outputting cooking instructions as soon as an order is received when a non-course menu is ordered by a customer because cooking instructions can be outputted for a selected menu can be outputted to the kitchen by pushing down the “Fire” button 161 after choosing either one of the ordered menus. On the other hand, if the customer wants to have a particular menu having an older “Hold Number” served earlier than the other menus in case of a course menu, it is possible to prioritize in outputting cooking instructions for a chosen particular menu.

A fourth exemplary advantage according to the invention is that by pushing down the “Fire” button 161 after inputting any numerical value representing the “Hold Number”, it is possible to output to the kitchen printer 2 cooking instructions for the menus having the same “Hold Number” as the inputted numerical value among the ordered menus (products) excluding the menus (products) whose cooking instructions have been outputted to the kitchen printer 2. Accordingly, when customers in a group who ordered the same or different course menus but want to change the order of the menus to be served, for example to prioritize a menu having an older “Hold Number”, it is possible to output cooking instructions by simply inputting a certain “Hold Number” without the need for selecting names of plural menus, thereby enabling to select menus having the same “Hold Number”.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the appended claims. For instance, exemplary embodiments of the invention may be defined as follows in addition to the exemplary embodiment (1) that is mentioned in the summary of the invention hereinabove:

(2) A POS register of the above (1) characterized in that in case of different course menus, the same hold number is given to each menu having the same positioning in the respective course menus.

(3) A POS register of the above (1) characterized in that if cooking instructions for the selected menu are not outputted yet at the time of pushing down the fire button when an order for a non-course menu is received or when either one menu of an ordered course menu is selected, cooking instructions for the selected menu are outputted to the kitchen.

(4) A POS register of the above (1) characterized in that when the fire button is pushed down under the condition of inputting a numerical value corresponding to the hold number of the ordered course menu, cooking instructions for all menus having the hold number corresponding to the inputted numerical value are outputted to the kitchen excluding those menus of the course menus whose cooking instructions are outputted to the kitchen.

(5) A POS register of the above (1), wherein the cooking instructions to be outputted to the kitchen are printed on a cooking instruction sheet from a kitchen printer installed in the kitchen.

(6) A cooking instruction method of a POS register to be used in a shop such as a restaurant having a kitchen for cooking and serving menus as products, comprising the steps of:

setting and registering information on all menus available in the shop as products in a product master setting table together with a hold number for each menu indicating the sequential order to be served in case of a course menu; and

outputting to the kitchen the cooking instructions for the menu having the earliest hold number among menus of a course menu whose cooking instructions are not outputted yet when an order for a course menu is received and a fire button is pushed down for effecting cooking instructions to the kitchen.

(7) A cooking instruction method of the above (6), wherein the same hold number is given to each menu of different course menus if the positioning of the menu in the respective course menus is the same.

(8) A cooking instruction method of the above (6), characterized in that under the condition of receiving an order of a non-course menu or selecting either one menu of a course menu, if cooking instructions for the selected menu are not outputted yet when the fire button is pushed down, cooking instructions for the selected menu is outputted to the kitchen.

(9) A cooking instruction method of the above (6), characterized in that when the fire button is pushed down under the condition of inputting a numerical value corresponding to the hold number of the ordered course menu, cooking instructions are outputted to the kitchen for all menus of the ordered course menu having the hold number corresponding to the inputted numerical value but excluding the menus whose cooking instructions have been outputted.

(10) A cooking instruction method of the above (6), wherein the cooking instructions to the kitchen is outputted in printing on a cooking instruction sheet from a kitchen printer installed in the kitchen.

(11) A POS register to be used in a shop such as a restaurant or the like for timely sending cooking instructions to a kitchen to cook menus ordered by customers, comprising:

a product master setting table for setting and registering information about all available menus of the shop together with the Hold Number indicating the sequential order to serve in case of course menus;

an ordered menu setting table for setting and registering information about menus ordered by customers with reference to the product master setting table; and

a Fire button for outputting the cooking instructions of each menu in the ordered menu setting table to the kitchen.

(12) A POS register of the above (11) further comprising indication means for distinguishing served and un-served menus ordered by the customers.

(13) A POS register of the above (11), wherein the POS register is a portable type to be carried by a floor staff of the shop and comprises wireless communication means for communicating with a control unit in the shop by way of radio wave or infrared ray.

(14) A cooking instruction method for sending cooking instructions to a kitchen of a shop such as a restaurant or the like to serve menus ordered by customers using a POS register, comprising the steps of:

setting and registering in a product master setting table in the POS register about all product information available in the shop including a Hold Number indicating the sequential order of serving menus in case of course menus;

registering menus ordered by the customers in an ordered menu setting table with reference to the product master setting table; and

outputting cooking instructions to the kitchen when a Fire button of the POS terminal is pushed down after receiving the order in case of non-course menus but based on the Hold Number in case of course menus.

(15) A cooking instruction method of the above (14), wherein the cooking instructions outputted to the kitchen are printed in a kitchen printer installed in the kitchen.

(16) A cooking instruction program for implementing the cooking instruction method of either one of the above (6)-(10) and 14-15 in a computer executable program.

(17) A program recording medium for recording the cooking instructions of the above (16) in a computer readable recording medium.

What is claimed is:

1. A POS register to be used in a shop such as a restaurant provided with a kitchen for cooking and serving meals as products, comprising:
a product master table for setting and registering information on all menus of the products together with a hold number for each menu of a course menu representing the sequential order for cooking instructions; and
a fire button for effecting cooking instructions to the kitchen;
when the fire button is pushed down upon receiving an order for a course menu, cooking instructions for each menu of the course menu whose cooking instructions are not outputted and having the earliest order in the hold number are outputted to the kitchen.

2. A POS register of claim 1 characterized in that in case of different course menus, the same hold number is given to each menu having the same positioning in the respective course menus.

3. A POS register of claim 1 characterized in that if cooking instructions for the selected menu are not outputted yet at the time of pushing down the fire button when an order for a non-course menu is received or when either one menu of an ordered course menu is selected, cooking instructions for the selected menu are outputted to the kitchen.

4. A POS register of claim 1 characterized in that when the fire button is pushed down under the condition of inputting a numerical value corresponding to the hold number of the ordered course menu, cooking instructions for all menus having the hold number corresponding to the inputted numerical value are outputted to the kitchen excluding those menus of the course menus whose cooking instructions are outputted to the kitchen.

5. A POS register of claim 1, wherein the cooking instructions to be outputted to the kitchen are printed on a cooking instruction sheet from a kitchen printer installed in the kitchen.

6. A cooking instruction method of a POS register to be used in a shop such as a restaurant having a kitchen for cooking and serving menus as products, comprising the steps of:
setting and registering information on all menus available in the shop as products in a product master setting table together with a hold number for each menu indicating the sequential order to be served in case of a course menu; and
outputting to the kitchen the cooking instructions for the menu having the earliest hold number among menus of a course menu whose cooking instructions are not outputted yet when an order for a course menu is received and a fire button is pushed down for effecting cooking instructions to the kitchen.

7. A cooking instruction method of claim 6, wherein the same hold number is given to each menu of different course menus if the positioning of the menu in the respective course menus is the same.

8. A cooking instruction method of claim 6, characterized in that under the condition of receiving an order of a non-course menu or selecting either one menu of a course menu, if cooking instructions for the selected menu are not outputted yet when the fire button is pushed down, cooking instructions for the selected menu is outputted to the kitchen.

9. A cooking instruction method of claim 6, characterized in that when the fire button is pushed down under the condition of inputting a numerical value corresponding to the hold number of the ordered course menu, cooking instructions are outputted to the kitchen for all menus of the ordered course menu having the hold number corresponding to the inputted numerical value but excluding the menus whose cooking instructions have been outputted.

10. A cooking instruction method of claim 6, wherein the cooking instructions to the kitchen is outputted in printing on a cooking instruction sheet from a kitchen printer installed in the kitchen.

11. A POS register to be used in a shop such as a restaurant or the like for timely sending cooking instructions to a kitchen to cook menus ordered by customers, comprising:
a product master setting table for setting and registering information about all available menus of the shop together with the Hold Number indicating the sequential order to serve in case of course menus;
an ordered menu setting table for setting and registering information about menus ordered by customers with reference to the product master setting table; and
a Fire button for outputting the cooking instructions of each menu in the ordered menu setting table to the kitchen.

12. A POS register of claim 11 further comprising indication means for distinguishing served and un-served menus ordered by the customers.

13. A POS register of claim 11, wherein the POS register is a portable type to be carried by a floor staff of the shop and comprises wireless communication means for communicating with a control unit in the shop by way of radio wave or infrared ray.

14. A cooking instruction method for sending cooking instructions to a kitchen of a shop such as a restaurant or the like to serve menus ordered by customers using a POS register, comprising the steps of:
setting and registering in a product master setting table in the POS register about all product information available in the shop including a Hold Number indicating the sequential order of serving menus in case of course menus;
registering menus ordered by the customers in an ordered menu setting table with reference to the product master setting table; and
outputting cooking instructions to the kitchen when a Fire button of the POS terminal is pushed down after receiving the order in case of non-course menus but based on the Hold Number in case of course menus.

15. A cooking instruction method of claim 14, wherein the cooking instructions outputted to the kitchen are printed in a kitchen printer installed in the kitchen.

16. A cooking instruction program for implementing the cooking instruction method of claim 6 in a computer executable program.

17. A program recording medium for recording the cooking instructions of claim 16 in a computer readable recording medium.
